(19) United States
(12) Patent Application Publication
(10) Pub. No.: US 2024/0282970 A1
(43) Pub. Date: Aug. 22, 2024

(54) SOLID-STATE ELECTRODES WITH IONIC AND ELECTRONIC GRADIENTS

(71) Applicant: GM GLOBAL TECHNOLOGY OPERATIONS LLC, Detroit, MI (US)

(72) Inventors: Qili SU, Shanghai (CN); Zhe Li, Shanghai (CN); Yong Lu, Shanghai (CN); Haijing Liu, Shanghai (CN); Dave G. Rich, Sterling Heights, MI (US)

(21) Appl. No.: 18/336,221

(22) Filed: Jun. 16, 2023

(30) Foreign Application Priority Data
Feb. 16, 2023 (CN) 202310126744.7

(51) Int. Cl. H01M 4/62; H01M 4/131; H01M 4/133; H01M 4/134; H01M 4/136; H01M 4/36; H01M 4/38; H01M 4/485; H01M 4/505; H01M 4/525; H01M 4/58; H01M 4/587; H01M 10/0525; H01M 10/0565

(52) U.S. Cl. CPC H01M 4/625; H01M 4/131; H01M 4/133; H01M 4/134; H01M 4/136; H01M 4/366; H01M 4/386; H01M 4/485; H01M 4/505; H01M 4/525; H01M 4/5815; H01M 4/5825; H01M 4/587; H01M 10/0525; H01M 10/0565; H01M 2300/0085

(57) ABSTRACT

An electrode for a lithium-ion battery cell includes a first region having a first thickness and including an active material comprising a first wt % of the first region and a solid electrolyte comprising a second wt % of the first region. A second region has a second thickness and includes the active material comprising a third wt % of the second region and the solid electrolyte comprising a fourth wt % of the second region. The first region and the second region are arranged adjacent to one another. The first wt % is greater than the third wt % and the second wt % is less than the fourth wt %.

### CROSS-REFERENCE TO RELATED APPLICATIONS

This application claims the benefit of Chinese Patent Application No. 202310126744.7, filed on Feb. 16, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to solid-state electrodes with ionic and electronic gradients.

Electric vehicles (EVs) such as battery electric vehicles (BEVs), hybrid vehicles, and/or fuel cell vehicles include one or more electric machines and a battery system including one or more battery cells, modules and/or packs. A power control system is used to control charging and/or discharging of the battery system during charging and/or driving. Manufacturers of EVs are pursuing increased power density to increase the range of the EVs.

Solid-state batteries (SSB) with solid electrolyte have the potential to be superior to the state-of-the-art lithium-ion batteries (LIB) in terms of abuse tolerance, working temperature range and system design. In current SSB electrodes, the electrodes are homogenous with balanced ionic and electronic conductivity (obtained by selecting and tuning active material (AM), solid electrolyte (SE), and/or carbon components and/or ratios).

### SUMMARY

An electrode for a lithium-ion battery cell includes a first region having a first thickness and including an active material comprising a first wt % of the first region and a solid electrolyte comprising a second wt % of the first region. A second region has a second thickness and includes the active material comprising a third wt % of the second region and the solid electrolyte comprising a fourth wt % of the second region. The first region and the second region are arranged adjacent to one another. The first wt % is greater than the third wt % and the second wt % is less than the fourth wt %.

In other features, the first wt % of the active material in the first region is greater than 75 wt %. The second wt % of the solid electrolyte in the first region is greater than 0 wt % and less than 25 wt %. The third wt % of the active material in the second region is greater than 0 wt % and less than 65 wt %. The fourth wt % of the solid electrolyte in the second region is greater than 35 wt %.

In other features, a middle region is arranged between the first region and the second region, having a third thickness, and including the active material comprising a fifth wt % of the middle region and the solid electrolyte comprising a sixth wt % of the middle region. The fifth wt % is less than the first wt % and greater than the third wt % and the sixth wt % is greater than the second wt % and less than the fourth wt %.

In other features, the first wt % of the active material in the first region is greater than 75 wt %. The second wt % of the solid electrolyte in the first region is greater than 0 wt % and less than 25 wt %. The third wt % of the active material in the second region is greater than 0 wt % and less than 65 wt %. The fourth wt % of the solid electrolyte in the second region is greater than 35 wt %. The fifth wt % of the active material in the middle region is greater than 65 wt % and less than 75 wt %. The sixth wt % of the solid electrolyte in the middle region is greater than 25 wt % and less than 35 wt %.

In other features, the first thickness is in a range from 10 μm to 150 μm, the second thickness is in a range from 10 μm to 100 μm, and the third thickness is in a range from 10 μm to 100 μm. The first region includes conductive agent in a range from 0.1 wt % to 2.0 wt %, the middle region includes the conductive agent in a range from 0.1 wt % to 1.5 wt %, and the second region includes the conductive agent in a range from 0.1 wt % to 1.0 wt %.

In other features, the conductive agent is selected from a group consisting of carbon black, graphite, graphene, graphene oxide, Super P, acetylene black, carbon nanofibers, and carbon nanotubes. The electrode comprises a cathode electrode. The active material is selected from a group consisting of a rock salt layered oxide, a polyanion cathode, an olivine cathode, and a lithium transition-metal oxide. The electrode comprises an anode electrode. The active material is selected from a group consisting of a carbonaceous material, a metal oxide, a metal sulfide, and Li₄Ti₅O₁₂.

In other features, the solid electrolyte is selected from a group consisting of pseudobinary sulfide, pseudoternary sulfide, pseudoquaternary sulfide, hydride-based solid electrolyte, and hydride-based solid electrolyte. The solid electrolyte comprises a gel polymer electrolyte. The gel polymer electrolyte comprises a polymer and a plasticizer including a lithium salt and a solvent.

In other features, the polymer is selected from a group consisting of a Nitrile-based solid polymer electrolyte, polyether, polyester-based solid polymer, PVDF, PVDF-HFP, and combinations thereof. The lithium salt is selected from a group consisting of LiAsF₆, LiPF₆, LiFSI, LiClO₄, LiBF₄, LiDMSI, LiTFSI, LiBETI, LiBOB, LiDFOB, and LiBFMB. The solvent is selected from a group consisting of carbonate solvent, lactone, nitrile, sulfone, ether, 1,3-dimethoxy propane, 1,4-Dioxane, phosphate and an ionic liquid.

In other features, the electrode comprises a cathode electrode, an anode electrode comprising N regions arranged in a thickness direction of the anode electrode, wherein each of the N regions of the anode electrode has a different ionic and electronic gradient, where N is an integer greater than one, and a solid electrolyte layer arranged between the cathode electrode and the anode electrode.

An anode electrode for a lithium-ion battery cell includes a first region having a first thickness and comprising a lithium-alloying active material comprising 100 wt % of the first region. A second region has a second thickness and comprising an anode active material having a second wt % greater than 0 wt % and less than 65 wt % of the second region, and a solid electrolyte having a third wt % greater than 35 wt % of the second region. The first region and the second region are arranged adjacent to one another.

In other features, a middle region arranged between the first region and the second region. The middle region has a third thickness and comprises the anode active material having a fourth wt % greater than 65 wt % and less than 99 wt % of the middle region, and the solid electrolyte having a fifth wt % greater than 1 wt % and less than 35 wt % of the middle region.

In other features, the second region comprises a conductive agent in a range from 0.1 wt % to 1.0 wt %, and the middle region comprises a conductive agent in a range from 0.1 wt % to 1.5 wt %. The lithium-alloying active material comprises silicon. The anode active material is selected from a group consisting of a carbonaceous material, a metal oxide, a metal sulfide, and Li₄Ti₅O₁₂.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is a side cross sectional view of an example of an electrode including ionic and electronic gradients in a thickness direction of the electrode according to the present disclosure;

FIG. 1B illustrates lithium-ion transport through the solid electrolyte for the electrode of FIG. 1A;

FIG. 1C illustrates electron transport through the active material/conductive agent for the electrode of FIG. 1A;

FIG. 2A is a side cross sectional view of another example of an electrode including ionic and electronic gradients in a thickness direction of the electrode according to the present disclosure;

FIG. 2B illustrates lithium-ion transport through the solid electrolyte for the electrode of FIG. 2A;

FIG. 2C illustrates electron transport through the active material/conductive agent for the electrode of FIG. 2A;

FIG. 3A is a side cross sectional view of another example of an electrode including ionic and electronic gradients in a thickness direction of the electrode according to the present disclosure;

FIG. 3B illustrates lithium-ion transport through the solid electrolyte for the electrode of FIG. 3A;

FIG. 3C illustrates electron transport through the active material/conductive agent for the electrode of FIG. 3A;

FIG. 4 illustrates an example of a method for manufacturing an electrode including ionic and electronic gradients according to the present disclosure;

FIGS. 5A to 5E illustrate an example of a method for manufacturing the electrode of FIG. 2A according to the present disclosure;

FIGS. 6A to 6D illustrate another example of a method for manufacturing the electrode of FIG. 2A according to the present disclosure; and

FIGS. 7A to 7C illustrate examples of battery cells including electrodes with ionic and electronic gradients according to the present disclosure.

In the drawings, reference numbers may be reused to identify similar and/or identical elements.

### DETAILED DESCRIPTION

While the battery cells are described herein in the context of EVs, the battery cells can be used in stationary applications and/or in other applications.

The present disclosure relates to solid-state electrodes with ionic and electronic gradients in a direction parallel to the electrode thickness. The ionic and electronic gradients enable high-power capability and high active material utilization with balanced energy output. The electrodes comprise two or more regions having different ionic and electronic gradients in a thickness direction of the electrodes. Electrodes with effective electronic and ionic pathways along a thickness of the electrode are configured to enhance electrochemical performance (e.g., active material capacity utilization, power performance) of the solid-state battery.

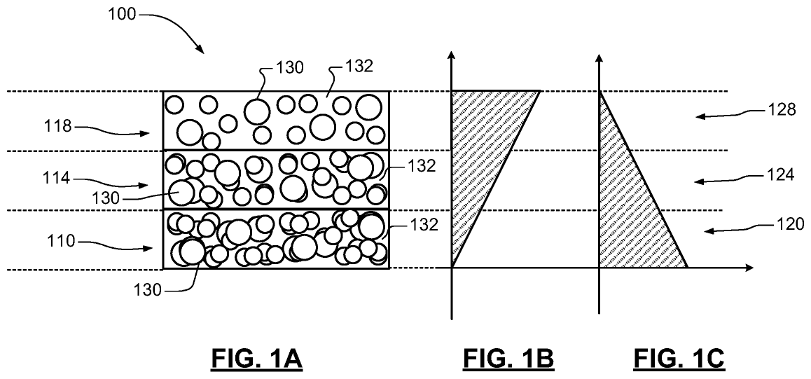

Referring now to FIGS. 1A to 1C, an electrode 100 is shown. The electrode 100 includes a first region 110, a middle region 114, and a second region 118. The first region 110 includes an active material 130, a conductive agent, and/or a solid electrolyte 132. The first region 110 includes a high electronic conductivity pathway provided by the active material 130 and the conductive agent and an ionic conductivity pathway provided by the solid electrolyte 132. The first region 110 corresponds to an energy region 120.

The middle region 114 is optional and includes the active material 130, the conductive agent, and/or the solid electrolyte 132. The middle region 114 has a moderate ionic pathway provided by the solid electrolyte 132 and moderate electronic conductivity provided by the active material 130 and the conductive agent. The middle region 114 corresponds to a power/energy region 124.

The second region 118 includes the active material 130, the conductive agent, and the solid electrolyte 132. The second region 118 has a high Li+ ionic conductivity pathway enabled by a high volume ratio of the solid electrolyte 132 and acceptable electronic conductivity provided by the active material 130 and the conductive agent. The second region 118 corresponds to the power region 128.

In some examples, the first region 110 includes a higher ratio of the active material 130 and a lower ratio of the solid electrolyte 132 than the middle region 114. In some examples, the middle region 114 includes a higher ratio of the active material 130 and a lower ratio of the solid electrolyte 132 than the second region 118.

In some examples, the first region 110 has a thickness in a range from 10 μm to 150 μm. The first region 110 includes the active material 130 comprising greater than 75 wt %, the solid electrolyte 132 in a range from 1 wt % to 25 wt %, and conductive agent in a range from 0 wt % (or 0.1 wt %) to 2 wt %.

In some examples, the middle region 114 has a thickness in a range from 0 μm to 100 μm. In some examples, the middle region 114 comprises the active material 130 in a range from 65 wt % to 75 wt %, the solid electrolyte 132 in a range from 25 wt % to 35 wt %, and the conductive agent in a range from 0 wt % (or 0.1 wt %) to 1.5 wt %.

In some examples, the second region 118 has a thickness in a range from 10 μm to 100 μm. In some examples, the second region 118 comprises the active material 130 in a range from 50 wt % to 65 wt %, the solid electrolyte 132 in a range from 35 wt % to 50 wt %, and the conductive agent in a range from 0 wt % (or 0.1 wt %) to 1.0 wt %.

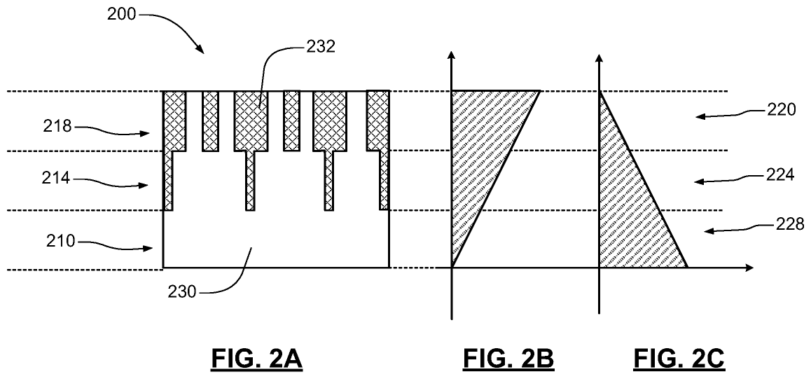

Referring now to FIGS. 2A to 2C, an electrode 200 including an active material 230 and a solid electrolyte 232 is shown. In some examples, the active material 230 includes lithium-alloying active material. The electrode 200 includes a first region 210, a middle region 214, and a second region 218. The first region 210 includes a high electronic conductivity pathway conducted through the active material 230. The first region 210 corresponds to an energy region 220.

The middle region 214 is optional and has moderate ionic conductivity provided by the solid electrolyte 232, moderate electronic conductivity provided by the active material 230, and corresponds to a power/energy region 224. The second region 218 has a high Li⁺ ionic conductivity pathway enabled by a higher ratio of the solid electrolyte 232 and electronic conductivity provided by the active material 230. The second region 218 corresponds to the power region 228.

In some examples, the first region 210 includes a higher ratio of the active material 230 than the middle region 214. In some examples, the middle region 214 includes a higher ratio of the active material 230 and a lower ratio of the solid electrolyte 232 than the second region 218.

In some examples, the first region 210 has a thickness in a range from 1 μm to 60 μm. In some examples, the first region 210 includes the active material 230 comprising 100 wt %. In some examples, the middle region 214 has a thickness in a range from 0 μm to 100 μm. In some examples, the middle region 214 comprises the active material 230 in a range from 80 wt % to 99 wt % and the solid electrolyte 232 in a range from 1 wt % to 20 wt %.

In some examples, the second region 218 has a thickness in a range from 10 μm to 100 μm. In some examples, the second region 218 comprises the active material 230 in a range from 50 wt % to 79 wt % and the solid electrolyte 232 in a range from 21 wt % to 50 wt %.

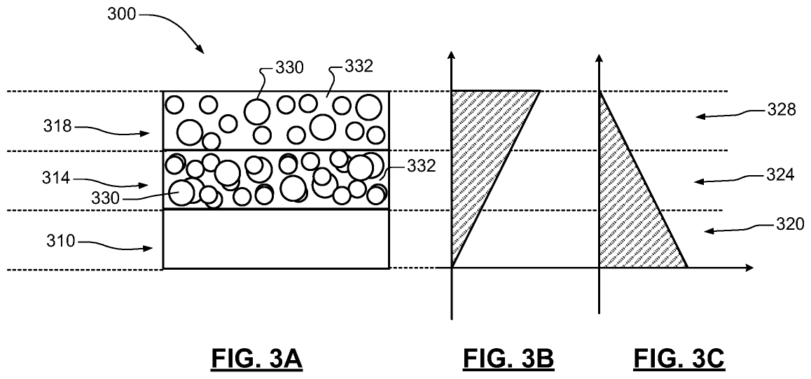

Referring now to FIGS. 3A to 3C, an electrode 300 is shown. The electrode 200 includes a first region 310, a middle region 314, and a second region 318. The first region 310 includes a high electronic conductivity pathway conducted through an active material 330. The first region 310 corresponds to an energy region 320. The middle region 314 comprises the active material 330 and a solid electrolyte 332. The middle region 314 is optional and has moderate ionic conductivity provided by the solid electrolyte 332, and moderate electronic conductivity provided by the active material 330. The middle region 314 corresponds to a power/energy region 324.

The second region 318 has a high Li+ ionic conductivity pathway enabled by a high ratio of the solid electrolyte 332 and electronic conductivity provided by the active material 330. The second region 318 corresponds to the power region 328.

In some examples, the first region 310 includes a higher ratio of the active material 330 than the middle region 314. In some examples, the middle region 314 includes a higher ratio of the active material 330 and a lower ratio of the solid electrolyte 332 than the second region 318.

In some examples, the first region 310 has a thickness in a range from 1 μm to 60 μm. The first region 310 includes the active material 330. In some examples, the active material 330 comprises Li-alloying active material (e.g., 100%).

In some examples, the middle region 314 has a thickness in a range from 0 μm to 100 μm. In some examples, the middle region 314 comprises the active material 330 in a range from 65 wt % to 99 wt %, the solid electrolyte 332 in a range from 1 wt % to 35 wt %, and the conducting agent from 0 wt % (or 0.1 wt %) to 1.5 wt %.

In some examples, the second region 318 has a thickness in a range from 10 μm to 100 μm. In some examples, the second region 318 comprises active material 330 in a range from 50 wt % to 65 wt %, the solid electrolyte 332 in a range from 35 wt % to 50 wt %, and the conductive agent in a range from 0 wt % (or 0.1 wt %) to 1.0 wt %.

Referring now to FIG. 4, a method 400 for manufacturing an electrode with ionic and electronic gradients in a direction parallel to the electrode thickness is shown. A film corresponding the second region 118 of the electrode is prepared by supplying a mixture 422 of materials to first and second rollers 424 and 426. The mixture 422 includes the active material, the solid electrolyte, the conductive agent and/or binder in the ratios described above.

The film is guided by a roller 428 to rollers 429 and 450. A film including the middle region 114 is prepared by supplying a mixture 432 between rollers 434 and 436. The mixture 432 includes the active material, the solid electrolyte, the conductive agent and/or binder in the ratios described above. The film is supplied to the rollers 429 and 450.

A film including the first region 110 of the electrode is prepared by supplying a mixture 442 of materials to first and second rollers 444 and 446. The mixture 442 includes the active material, the solid electrolyte, the conductive agent and/or binder in the ratios described above. The film is guided by a roller 448 to the rollers 429 and 450. The rollers 429 and 450 apply heat and/or pressure to form the electrode that is stored on a roller 460.

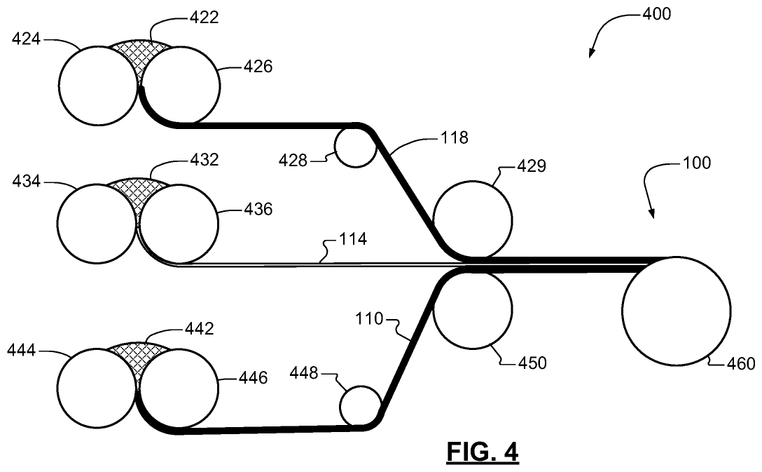

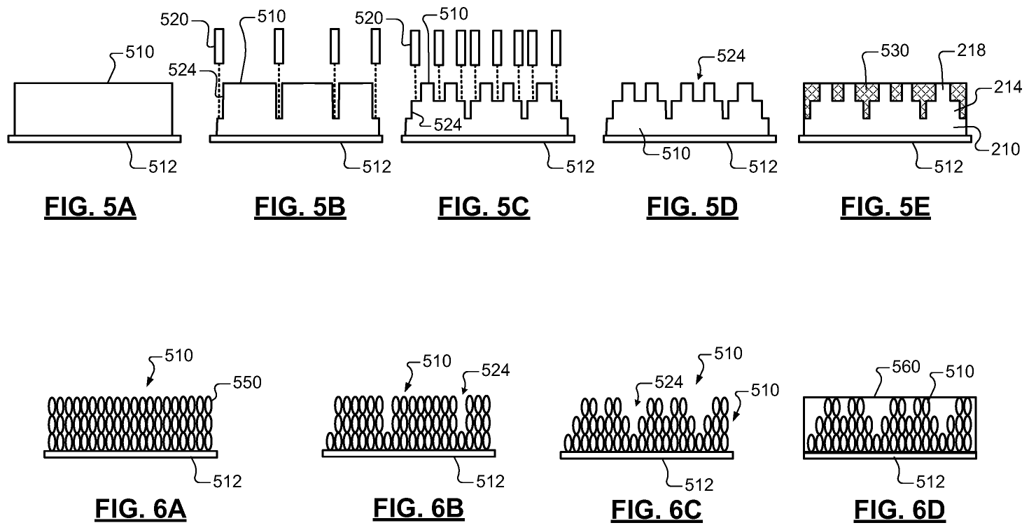

Referring now to FIGS. 5A to 5E, a method for preparing the electrode of FIG. 2A is shown. In FIG. 5A, an alloy-type film 510 (e.g., silicon) is arranged on a current collector 512. In FIG. 5B, one or more lasers 520 define cavities 524 extending vertically into a middle portion of the alloy-type film 510. In FIG. 5C, one or more lasers 520 define cavities 524 in an upper portion the alloy-type film 510. In FIGS. 5D and 5E, after processing using the lasers 520, the cavities 524 are filled with solid electrolyte 530 to define the middle region 214 and the second region 218.

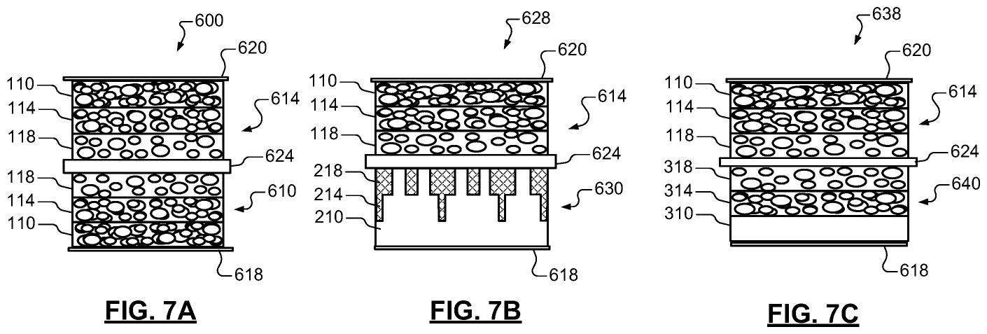

Referring now to FIGS. 6A to 6C, the alloy-type film may include layers of silicon columns 550 that are ablated by the lasers to create the cavities 524. For example, Si columns are initially ablated in both the upper and middle rows as shown in FIG. 6B and additional columns are ablated in the upper row as shown in FIG. 6C to adjust ionic and electronic gradients. After forming the cavities 524, solid electrolyte 560 fills the cavities 524.

Referring now to FIGS. 7A to 7C, examples of battery cells including electrodes with ionic and electronic gradients in a direction parallel to the electrode thickness are shown. In FIG. 6A, a battery cell 600 includes a cathode electrode 614 including the first region 110, the middle region 114, the second region 118, and a cathode current collector 620. The battery cell 600 includes an anode electrode 610 including the first region 110, the middle region 114, the second region 118, and an anode current collector 618. A separating layer 624 is arranged between the cathode electrode 614 and the anode electrode 610.

In FIG. 7B, a battery cell 628 includes the cathode electrode 614 including the first region 110, the middle region 114, the second region 118, and the cathode current collector 620. The battery cell 628 includes an anode electrode 630 including the first region 210, the middle region 214, the second region 218, and the anode current collector 618. The separating layer 624 is arranged between the cathode electrode 614 and the anode electrode 630.

In FIG. 7C, a battery cell 638 includes the cathode electrode 614 including the first region 110, the middle region 114, the second region 118, and the cathode current collector 620. The battery cell 628 includes an anode electrode 640 including the first region 310, the middle region 314, the second region 318, and the anode current collector 618. The separating layer 624 is arranged between the cathode electrode 614 and the anode electrode 640.

In some examples, the cathode active material comprises at least one of rock salt layered oxides (LiCoO₂, LiNiₓMn_{y}Co_{1-x-y}O₂, LiNiₓMn_{y}Al_{1-x-y}O₂, LiNiₓMn₁₋ₓO₂, Li₁₊ₓMO₂), spinel (LiMn₂O₄, LiNi_{0.5}Mn_{1.5}O₄), polyanion cathode (LiV₂(PO₄)₃), olivine cathode (LiFePO₄ and LiMnₓFe₁₋ₓPO₄) and other lithium transition-metal oxides, surface-coated and/or doped cathode materials mentioned above (e.g., LiNbO₃-coated LiMn₂O₄, Li₂ZrO₃ or Li₃PO₄-coated LiNiₓMn_{y}Co_{1-x-y}O₂, and Al-doped LiMn₂O₄), and low voltage cathode material. e.g., lithiated metal oxide/sulfide (e.g., LiTiS₂), lithium sulfide, and sulfur.

In some examples, the anode active material comprises at least one of carbonaceous material (e.g., graphite, hard carbon, soft carbon etc.), metal oxide/sulfide (e.g., TiO₂, FeS, etc.), Li₄Ti₅O₁₂ and other lithium-accepting anode materials, Li alloy-type material (e.g., silicon, transition-metal (e.g., Sn, In)), and combinations of above materials.

In some examples, the conductive additive comprises at least one of carbon black, graphite, graphene, graphene oxide, Super P, acetylene black, carbon nanofibers, carbon nanotubes and other electronically conductive additives.

In some examples, the binder comprises at least one of polytetrafluoroethylene (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS) and so on.

In some examples, the solid electrolyte is selected from a group consisting of pseudobinary sulfide, pseudoternary sulfide, pseudoquaternary sulfide, halide-based solid electrolyte, and hydride-based solid electrolyte.

Examples of pseudobinary sulfide include Li₂S—P₂S₅ system (Li₃PS₄, Li₇P₃S₁₁ and Li_{9.6}P₃S₁₂), Li₂S—SnS₂ system (Li₄SnS₄), Li₂S—SiS₂ system, Li₂S—GeS₂ system, Li₂S—B₂S₃ system, Li₂S—Ga₂S₃ system, Li₂S—P₂S₃ system, and Li₂S—Al₂S₃ system. Examples of pseudoternary sulfide include Li₂O—Li₂S—P₂S₅ system, Li₂S—P₂S₅—P₂O₅ system, Li₂S—P₂S₅—GeS₂ system (Li_{3.25}Ge_{0.25}P_{0.75}S₄ and Li₁₀GeP₂S₁₂), Li₂S—P₂S₅—LiX (X=F, Cl, Br, I) system (Li₆PS₅Br, Li₆PS₅Cl, L₇P₂S₈I and Li₄PS₄I), Li₂S—As₂S₅—SnS₂ system (Li_{3.833}Sn_{0.833}As_{0.166}S4), Li₂S—P₂S₅—Al₂S₃ system, Li₂S—LiX—SiS₂ (X=F, Cl, Br, I) system, 0.4LiI·0.6Li₄SnS₄, and Li₁₁Si₂PS₁₂. Examples of pseudoquaternary sulfide include Li₂O—Li₂S—P₂S₅—P₂O₅ system, Li_{9.54}Si_{1.74}P_{1.44}S_{11.7}Cl_{0.3}, Li₇P_{2.9}Mn_{0.1}S_{10.7}I_{0.3} and Li_{10.35}[Sn_{0.27}Si_{1.08}]P_{1.65}S₁₂.

Examples of halide-based solid electrolyte include Li₃YCl₆, Li₃InCl₆, Li₃YBr₆, LiI, Li₂CdCl₄, Li₂MgCl₄, Li₂CdI₄, Li₂ZnI₄, Li₃OCl. Examples of hydride-based solid electrolyte include LiBH₄, LiBH₄—LiX (X=Cl, Br, or I), LiNH₂, Li₂NH, LiBH₄—LiNH₂, Li₃AlH₆. In other examples, other solid electrolyte that possesses low grain-boundary resistance is used.

In some examples, the solid electrolyte comprises a gel polymer electrolyte including a polymer host and a plasticizer. In some examples, solid electrolyte comprises 0.1 wt % to 50 wt % of the polymer host and 5 wt % to 90 wt % of the plasticizer.

In some examples, the polymer host includes one or more materials selected from a group consisting of nitrile-based solid polymer electrolytes (e.g., poly(acrylonitrile) (PAN); polyether (e.g., poly(ethylene oxide) (PEO)), poly(ethylene glycol) (PEG), polyester-based solid polymer (e.g., polyethylene carbonate (PEC), poly(trimethylene carbonate) (PTMC), and poly (propylene carbonate) (PPC)), and PVDF and/or PVDF-HFP, and combinations thereof.

In some examples, the plasticizer comprises lithium salt and solvent. In some examples, the lithium salt includes at least one material selected from a group consisting of LiAsF₆, LiPF₆, LiFSI, LiClO₄, LiBF₄, LiDMSI, LiTFSI, LiBETI, LiBOB, LiDFOB, and LiBFMB.

In some examples, the solvent comprises a material selected from a group consisting of carbonate solvents (e.g., ethylene carbonate (EC), propylene carbonate (PC), glycerol carbonate, vinylene carbonate, fluoroethylene carbonate and 1,2-Butylene carbonate); lactones (e.g., γ-butyrolactone and δ-valerolactone); nitriles (e.g., succinonitrile, glutaronitrile and adiponitrile); sulfones (e.g., tetramethylene sulfone, ethyl methyl sulfone, vinyl sulfone, phenyl sulfone, 4-fluorophenyl sulfone and benzyl sulfone); ethers (e.g., triethylene glycol dimethylether (triglyme, G3), tetraethylene glycol dimethylether (tetraglyme, G4), 1,3-dimethoxy propane and 1,4-Dioxane); phosphates (e.g., triethyl phosphate and trimethyl phosphate); and ionic liquids.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. An electrode for a lithium-ion battery cell, comprising:
a first region having a first thickness and including an active material comprising a first wt % of the first region and a solid electrolyte comprising a second wt % of the first region; and
a second region having a second thickness and including the active material comprising a third wt % of the second region and the solid electrolyte comprising a fourth wt % of the second region,
wherein the first region and the second region are arranged adjacent to one another,
wherein the first wt % is greater than the third wt % and the second wt % is less than the fourth wt %.

2. The electrode of claim 1, wherein:
the first wt % of the active material in the first region is greater than 75 wt %;
the second wt % of the solid electrolyte in the first region is greater than 0 wt % and less than 25 wt %;
the third wt % of the active material in the second region is greater than 0 wt % and less than 65 wt %; and
the fourth wt % of the solid electrolyte in the second region is greater than 35 wt %.

3. The electrode of claim 1, further comprising:
a middle region arranged between the first region and the second region, having a third thickness, and including the active material comprising a fifth wt % of the middle region and the solid electrolyte comprising a sixth wt % of the middle region,
wherein the fifth wt % is less than the first wt % and greater than the third wt % and the sixth wt % is greater than the second wt % and less than the fourth wt %.

4. The electrode of claim 3, wherein:
the first wt % of the active material in the first region is greater than 75 wt %,
the second wt % of the solid electrolyte in the first region is greater than 0 wt % and less than 25 wt %,
the third wt % of the active material in the second region is greater than 0 wt % and less than 65 wt %,
the fourth wt % of the solid electrolyte in the second region is greater than 35 wt %,
the fifth wt % of the active material in the middle region is greater than 65 wt % and less than 75 wt %; and
the sixth wt % of the solid electrolyte in the middle region is greater than 25 wt % and less than 35 wt %.

5. The electrode of claim 4, wherein:
the first thickness is in a range from 10 μm to 150 μm,
the second thickness is in a range from 10 μm to 100 μm, and
the third thickness is in a range from 10 μm to 100 μm.

6. The electrode of claim 5, wherein:
the first region includes conductive agent in a range from 0.1 wt % to 2.0 wt %,
the middle region includes the conductive agent in a range from 0.1 wt % to 1.5 wt %, and
the second region includes the conductive agent in a range from 0.1 wt % to 1.0 wt %.

7. The electrode of claim 6, wherein the conductive agent is selected from a group consisting of carbon black, graphite, graphene, graphene oxide, Super P, acetylene black, carbon nanofibers, and carbon nanotubes.

8. The electrode of claim 1, wherein:
the electrode comprises a cathode electrode, and
the active material is selected from a group consisting of a rock salt layered oxide, a polyanion cathode, an olivine cathode, and a lithium transition-metal oxide.

9. The electrode of claim 1, wherein:
the electrode comprises an anode electrode, and
the active material is selected from a group consisting of a carbonaceous material, a metal oxide, a metal sulfide, and Li₄Ti₅O₁₂.

10. The electrode of claim 1, wherein the solid electrolyte is selected from a group consisting of pseudobinary sulfide, pseudoternary sulfide, pseudoquaternary sulfide, hydride-based solid electrolyte, and hydride-based solid electrolyte.

11. The electrode of claim 1, wherein:
the solid electrolyte comprises a gel polymer electrolyte, and
wherein the gel polymer electrolyte comprises a polymer and a plasticizer including a lithium salt and a solvent.

12. The electrode of claim 11, wherein:
the polymer is selected from a group consisting of a Nitrile-based solid polymer electrolyte, polyether, polyester-based solid polymer, PVDF, PVDF-HFP, and combinations thereof,
the lithium salt is selected from a group consisting of LiAsF₆, LiPF₆, LiFSI, LiClO₄, LiBF₄, LiDMSI, LiTFSI, LiBETI, LiBOB, LiDFOB, and LiBFMB, and
the solvent is selected from a group consisting of carbonate solvent, lactone, nitrile, sulfone, ether, 1,3-dimethoxy propane, 1,4-Dioxane, phosphate and an ionic liquid.

13. A battery cell comprising:
the electrode of claim 1, wherein the electrode comprises a cathode electrode;
an anode electrode comprising N regions arranged in a thickness direction of the anode electrode, wherein each of the N regions of the anode electrode has a different ionic and electronic gradient, where N is an integer greater than one; and
a solid electrolyte layer arranged between the cathode electrode and the anode electrode.

14. An anode electrode for a lithium-ion battery cell, comprising:
a first region having a first thickness and comprising a lithium-alloying active material comprising 100 wt % of the first region; and
a second region having a second thickness and comprising an anode active material having a second wt % greater than 0 wt % and less than 65 wt % of the second region, and a solid electrolyte having a third wt % greater than 35 wt % of the second region,
wherein the first region and the second region are arranged adjacent to one another.

15. The anode electrode of claim 14, further comprising:
a middle region arranged between the first region and the second region,
wherein the middle region has a third thickness and comprises the anode active material having a fourth wt % greater than 65 wt % and less than 99 wt % of the middle region, and the solid electrolyte having a fifth wt % greater than 1 wt % and less than 35 wt % of the middle region.

16. The anode electrode of claim 15, wherein:
the second region comprises a conductive agent in a range from 0.1 wt % to 1.0 wt %; and
the middle region comprises a conductive agent in a range from 0.1 wt % to 1.5 wt %.

17. The anode electrode of claim 16, wherein:
lithium-alloying active material comprises silicon; and
the anode active material is selected from a group consisting of a carbonaceous material, a metal oxide, a metal sulfide, and Li₄Ti₅O₁₂.

18. An anode electrode for a lithium-ion battery cell, comprising:
an anode current collector;
a lithium-alloy film arranged on the anode current collector;
vertical cavities etched into the lithium-alloy film; and
solid electrolyte arranged in the vertical cavities and configured to define N regions in the anode electrode having different ionic and electronic gradients, where N is an integer greater than one.

19. The anode electrode of claim 18, wherein the lithium-alloy film comprises silicon.

20. The anode electrode of claim 18, wherein the solid electrolyte is selected from a group consisting of pseudobinary sulfide, pseudoternary sulfide, pseudoquaternary sulfide, hydride-based solid electrolyte, hydride-based solid electrolyte, and a gel polymer electrolyte.
